(19) United States
(12) Patent Application Publication
(10) Pub. No.: US 2023/0080634 A1
(43) Pub. Date: Mar. 16, 2023

(54) METHOD FOR PREPARING A FOOD TOGETHER WITH FOOD PROCESSOR

(71) Applicant: VORWERK & CO. INTERHOLDING GMBH, Wuppertal (DE)

(72) Inventors: Stefan Kraut-Reinkober, Leverkusen (DE); Gereon Feckler, Dormagen (DE); Andreas Merta, Wülfrath (DE); Wenjie Yan, Düsseldorf (DE)

(21) Appl. No.: 17/943,175

(22) Filed: Sep. 12, 2022

(30) Foreign Application Priority Data
Sep. 10, 2021 (EP) 21195957.2

(51) Int. Cl. A47J 36/32; A47J 27/00; A47J 44/00

(52) U.S. Cl. CPC A47J 36/32; A47J 27/004; A47J 44/00

(57) ABSTRACT

A method for a food processor including a pot, a heating element for heating the pot and/or a food in the pot, and a temperature sensor for determining an actual temperature (T_{I}) of the pot or the food in the pot, includes performing temperature control by a control device in a temperature control mode based on a desired temperature (T_{T}) by adjusting an electrical energy supplied to the heating element in dependence on the actual temperature (T_{I}) so that the actual temperature (T_{I}) approaches or reaches the desired temperature (T_{T}).

### CROSS-REFERENCE TO RELATED APPLICATION

This application claims the benefit of priority to European Application No. 21195957.2, filed Sep. 10, 2021, the disclosure of which is incorporated in its entirety by reference herein.

### TECHNICAL FIELD

The present disclosure relates to a method for preparing a food in a pot by means of a food processor with temperature control and a boiling detection unit, a corresponding food processor and a corresponding computer program product.

### BACKGROUND

The cooking behavior depends on the measuring accuracy of the temperature sensor and the environmental conditions, e.g. geographical altitude, level of the medium in the pot and the quality of the mixture by stirring, for example. In principle, controlling to a target temperature during the boiling process involves the discrepancy that the boiling temperature is defined by the physical properties of the medium and the environmental conditions present. Thus, the control may not reach its target temperature at all under certain circumstances. Depending on the control algorithm for the temperature, it thus sets an undefined heating power, which then leads to varying, sometimes non-reproducible cooking results.

### SUMMARY

The foregoing features known from the prior art may be combined individually or in any combination with any of the objects and configurations of the present disclosure described below.

It is the task of the present disclosure to provide a further developed method together with a food processor.

A method according to the main claim as well as a food processor and a computer program product according to the additional claims serve to solve the task. Advantageous configurations result from the subclaims.

A method for preparing a food in a pot, in particular by means of a food processor comprising the pot, a heating element for heating the pot and/or a food in the pot and a temperature sensor for determining an actual temperature of the pot and/or the food in the pot, serves to solve the task. The method preferably comprises the following step: Performing a temperature control, in particular by a control device, in a temperature control mode based on a desired temperature by adjusting an electrical energy supplied to the heating element in dependence on the actual temperature, so that the actual temperature approaches or reaches the desired temperature. The method preferably comprises the following step: Detecting a predetermined boiling stage of the food by a boiling detection unit. The method comprises the following step: Changing, in particular from the temperature control mode, to a fixed mode of the control device, preferably when the boiling detection unit detects the predetermined boiling stage, wherein the electrical energy supplied to the heating element is kept at a fixed value in the fixed mode. In particular, the fixed value depends on the desired temperature, a user input, a digital recipe or a recipe step of a digital recipe.

In this way, a reproducible cooking result can be achieved particularly reliably with a system that has a reduced complexity.

### BRIEF DESCRIPTION OF DRAWINGS

In the following, exemplary embodiments of the present disclosure are also explained in more detail with reference to figures. Features of the exemplary embodiments may be combined individually or in a plurality with the claimed subject matter and disclosed aspects of the present disclosure, unless otherwise indicated. The claimed scopes of protection are not limited to the exemplary embodiments.

The figures show:

FIG. 1: Schematic representation of a food processor;

FIG. 2: Representation of a schematic flow chart;

FIG. 3: Representation of a measurement diagram;

FIG. 4: Representation of a schematic flow chart according to an exemplary embodiment;

FIG. 5: Representation of a schematic flow chart according to a further exemplary embodiment.

### DETAILED DESCRIPTION

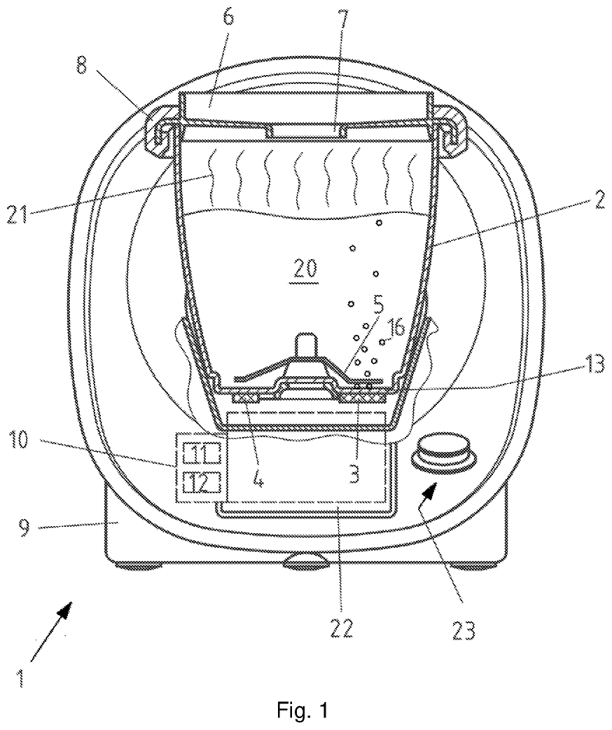

FIG. 1 shows a food processor 1 with a pot 2 for receiving a food 20 that includes liquid ingredients or is liquid. In particular, the food 20 is water. The pot 2 may be covered by a lid 6 having a lid opening 7. An opening cover, not shown, may be provided to loosely cover the lid opening 7 so that steam 21 can always escape from the pot 2. The lid 6 may be locked onto the pot by means of a lock 8. A rotatable tool 5 for chopping and/or mixing may optionally be provided on the pot bottom 13. A housing 9 of the food processor 1 stably accommodates the pot 2. A display 22 and a user interface 23 allow interaction with a user, in particular for making a user input to change or activate a fixed mode for keeping an electrical energy supplied to the heating element 3 at a fixed value depending on a desired boiling stage according to the user input. A control device 10 having a processor 11 and a memory 12 are provided to control the food processor. In one embodiment, at least a part of the control device 10 is outsourced to an external computer unit. A heating element 3 and a temperature sensor 4 are arranged in particular on an underside of the pot bottom 13, which normally does not come into contact with a food, preferably approximately centrally between a center of the pot bottom 13 and an outer circumference. Preferably, the heating element 3 and/or the temperature sensor 4 are directly connected to the pot 2, preferably to the pot bottom 13. A particularly efficient heating and/or a particularly precise measurement can thus be made possible. Preferably, the heating element 3 and the temperature sensor 4 are arranged opposite each other on both sides of the center of the pot bottom to enable particularly precise measurement.

The food 20 in the pot 2 of FIG. 1 is in a beginning boiling stage, which can be described as quiet boiling. In addition to the formation of steam 21, small bubbles 16 become visible in particular in the region of heating element 3 and rise to the surface from there, because the pot bottom 13 has the highest temperature in the region of the heating element 3. The food 20, on the other hand, has not yet reached the boiling temperature overall. This boiling stage of water is suitable, for example, for the preparation of sausages, dumplings or poached eggs in this quietly boiling water 20, because the consistency can be maintained.

The pot 2 is made of glass or metal, in particular stainless steel, and/or has a thickness of 0.5 to 1.0 mm. The diameter of the pot 2 is preferably between 12 cm and 17 cm. In particular, the pot bottom 13 has a smaller diameter (e.g., 11 cm to 14 cm) than the pot 2 on the upper side (e.g., 15 to 17 cm). Preferably, the temperature sensor 4 is a thermistor preferably with a negative temperature coefficient.

During normal heating of a liquid food 20 in the pot 2 below the boiling point, i.e., without vapor formation, the supply of heat power by the heating element 3 causes the temperature in the food 20 to rise. When the boiling point is reached, a first portion of the supplied heat power offsets losses from effluent heat and an optional second portion of the supplied heat power is consumed almost entirely for a phase change from liquid to vapor while the temperature remains substantially constant.

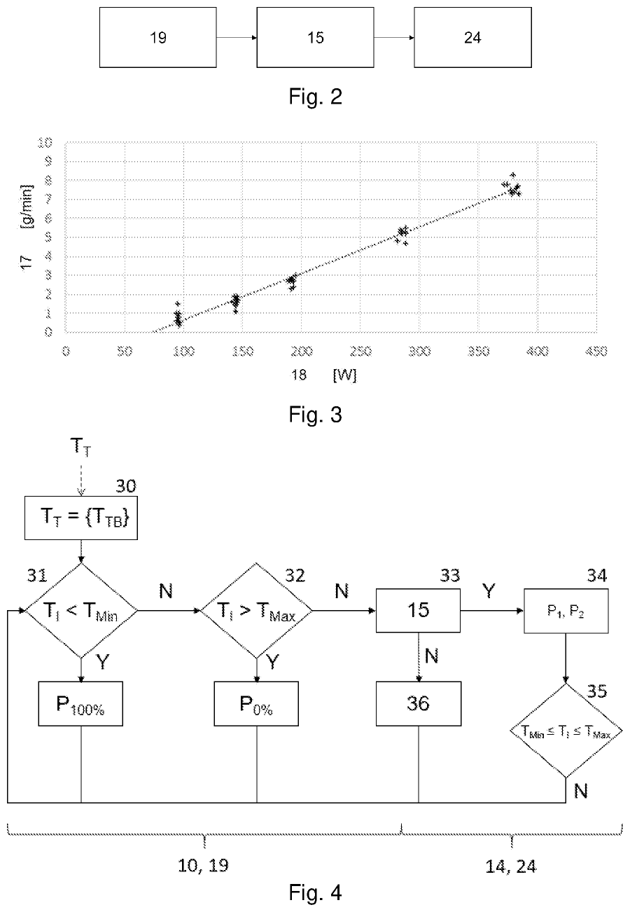

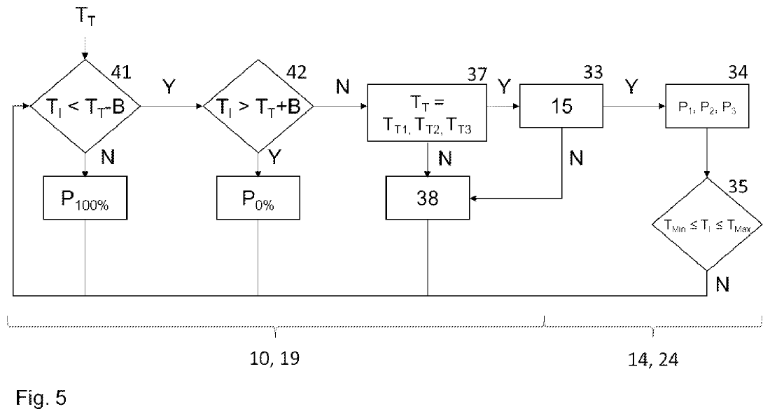

FIG. 2 shows a simplified flow chart that can be implemented by a food processor, in particular the food processor of FIG. 1. First, temperature control is performed in a temperature control mode 19. When a predetermined boiling stage has been detected by means of at least one boiling stage criterion 15, a change is made from the temperature control mode 19 to a fixed mode 24. Due to the electrical energy fixed in dependence on the desired temperature T_{T}, which is constantly supplied to the heating element in the fixed mode 24, the desired boiling stage can be obtained particularly reliably, e.g. a quiet boiling by a value P₁, a normal cooking by a value P₂ or a strong cooking by a value P₃. The values P₁, P₂, P₃ are explained in more detail below and illustrated with reference to FIGS. 4 and 5.

In temperature control mode 19, the actual temperature T_{I} is approximated to the desired temperature T_{T} by adjusting the electrical energy supplied to the heating element 3 (in particular the electrical power in watts). In temperature control, the electrical energy supplied to the heating element 3 does not remain constant over the entire period in temperature control mode 19. In fixed mode 24, however, the electrical energy supplied to the heating element 3 is kept at a constant value (e.g. P₁, P₂ or P₃ in FIGS. 4 and 5) for the entire period in fixed mode 24. This constant value depends on the desired temperature T_{T}, in particular according to a predefined association (assignment).

In one embodiment, the constant values (e.g., P₁, P₂, or P₃ in FIGS. 4 and 5) of the fixed mode 24 are predefined (in the control device 10) and/or are associated with boiling desired temperatures T_{T}, or boiling desired temperature ranges T_{TB} such that the following applies: each constant value results in a respective state of water that is desired, expected, and/or scheduled at the boiling desired temperature T_{Ti} or in the boiling desired temperature ranges T_{TB} at normal pressure (approximately 1 bar ambient pressure). If the desired temperature corresponds to one of the boiling desired temperatures T_{Ti} or falls within one of the boiling desired temperature ranges T_{TB}, such a condition is desired, expected or planned for the present food in the current food preparation process. Since many environmental influences, such as altitude above sea level, quality of mixing of the food or degree of contamination of the pot are not taken into account and can lead to errors in the conventional temperature control process, when the desired temperature is selected, entered or adjusted by the user or a digital recipe or user input with respect to a desired boiling stage, the constant value (e.g. P₁, P₂ or P₃ in FIGS. 4 and 5) for the supply of electrical energy to the heating element achieves a reproducible cooking result particularly reliably and with a not very complex system.

FIG. 3 shows a measurement of a steam rate 17 as a function of the heating power 18 during the cooking of water with the food processor of FIG. 1, wherein the measurement point clouds result from individual measurements, entered as “+”, under variation of the filling level in the pot 2 and the rotational speed of the tool 5. The filling level and the rotational speed show no measurable correlation to the vapor rate, which can be used as an indicator for the boiling stage. The intersection of a regression line (see dashed line through the point cloud in FIG. 3) of a linear single regression with the x-axis provides an experimentally determined heat loss at the boiling stage.

The constant value (P₁, P₂, P₃) for the electrical energy to be supplied to the heating element 3 is in particular a power value, a current intensity value or a voltage value, or can be realized by means of a pulse control over a predefined time window, preferably 3 seconds. Preferably, the value for the electrical energy to be supplied to the heating element 3 is a reference variable and a control of the energy to be supplied to the heating element 3 takes place in order to obtain an approximately constant heat supply by the heating element 3 according to the reference variable. As explained above, the constant value of the fixed mode 24 can be described in such a way that a first part of the supplied thermal power compensates for losses from effluent heat and an optional second part of the supplied thermal power serves almost entirely for a phase transformation from liquid to vapor while the temperature remains substantially constant.

In particular, the value P₁ for quiet boiling is defined such that the second part of the supplied heat power for phase transformation is approximately zero (or at most leads to a low steam rate of approximately 2 g/minute), so that mainly heat losses are compensated by the first part of the supplied heat power. The liquid food then behaves approximately like water at normal pressure with a temperature just below 100° C. Preferably, the value P₁ is defined such that a steam rate of at least 0.5 and/or at most 3 g/minute on average, preferably about 1 g/minute is produced. In particular, the value P₁ is associated with a boiling desired temperature (T^{T1}), e.g. 98° C. or plurality of boiling desired temperatures, e.g. 95° C., 96° C., 97° C., 98° C. and 99° C. In one embodiment, it is also provided that the value P₁ is associated with a boiling desired temperature ranges T_{TB} of less than 100° C. and/or greater than 95° C. At the value P₁, there is a formation of steam 22 and small bubbles 16 (cf. FIG. 1), particularly in the region of the heating element 3, but still no significant formation of large, visible and loudly audible bubbles, which are distributed over almost the entire, liquid food 20 in the pot 2. For example, the value P₁ is then an electrical power of 100 W.

In particular, the value P₂ for a normal cooking is defined such that the second part of the supplied heat power for the phase transformation is so large that heat losses are compensated by the first part of the supplied heat power and the second part of the supplied heat power results in a phase transformation with clearly visible and audible bubbles rising from the pot bottom to the surface of the liquid food and bursting there. Preferably, the value P₂ is defined such that a steam rate of at least 4 and/or at most 6 g/minute on average, preferably about 5 g/minute is produced. In particular, the value P₂ is associated with a boiling desired temperature (T_{T2}), e.g. 100° C. or plurality of boiling desired temperatures, e.g. 100° C., 101° C., 102° C., 103° C. and 104° C. In one embodiment, it is also provided that the value P₂ is associated with a boiling desired temperature ranges T_{TB} of at least 100° C. and/or at most 104° C. In one embodiment, the value P₂ corresponds to at least two times the value P₁ and/or the value P₂ is less than four times the value P₁. For example, the value P₂ is an electrical power of 300 W.

In particular, the value P₃ for strong cooking is defined such that the second part of the supplied heat power for the phase transformation is so large that heat losses are compensated by the first part of the supplied heat power and the second part of the supplied heat power results in a phase transformation with clearly visible and audible bubbles rising from the pot bottom to the surface of the liquid food and bursting there. Preferably, the value P₃ is defined such that a steam rate of at least 6 and/or at most 9 g/minute on average, preferably about 7.5 g/minute is produced. In particular, the value P₃ is associated with a boiling desired temperature (T_{T3}), e.g. 105° C. or a plurality of boiling desired temperatures, e.g. 105° C., 106° C., 107° C., 108° C. and 109° C. In one embodiment, it is also provided that the value P₁ is associated with a boiling desired temperature ranges T_{TB} of at least 105° C. and/or at most 109° C. In one embodiment, the value P₃ is at least three times the value P₁ and/or greater than the value P₂. For example, the value P₃ is then an electrical power of 400 W.

FIG. 4 shows a flow chart according to an exemplary embodiment of the present disclosure. On the basis of a desired temperature T_{T}, which is available to the control device 10 (e.g. by an input of a user or according to a recipe step of a digital recipe), a temperature control is carried out, in particular in a temperature control mode 19 by the control device 10.

In step 30, it is checked whether the desired temperature T_{T} lies within a boiling desired temperature range T_{TB}. The boiling desired temperature range T_{TB} is preferably limited by a lower range limit of 98° C. and/or an upper range limit of 105° C. Thus, it is detected if a desired temperature is present for which the fixed mode 24 is provided.

If the condition of step 30 is not fulfilled, a conventional temperature control is performed, which will be discussed in more detail in connection with FIG. 5. If the condition of step 30 is fulfilled, step 31 is performed.

In step 31 it is checked whether the actual temperature T_{I} is less than the minimum temperature T_{Min} (preferably 91° C.). If yes (Y), the heating element 3 is supplied with electrical energy at maximum power P100% (in particular 900 to 1000 W). If no (N), it is continued with step 32.

In step 32 it is checked whether the actual temperature T_{I} is greater than the maximum temperature T_{Max} (preferably 110° C.). If yes (Y), the power supply of heating element 3 is stopped, i.e. power P0% is set to zero. If, for example, all the liquid has evaporated, this case may occur. In ordinary heating, the check will usually give the result No (N), so continue with step 33.

By the fact that in step 31 a transition is made to step 32 and then, as a rule, immediately to step 33 already at an actual temperature T_{I} greater than preferably 91° C. it can be prevented that the condition of step 32 is not fulfilled at all, and consequently the change to fixed mode 24 is not made, e.g. in the mountains at an altitude where water is already boiling at 91° C., or for other environmental reasons.

In step 33, the boiling stage criterion 15 is checked, which is also explained in more detail with reference to the other exemplary embodiment of FIG. 5 and is implemented analogously in this exemplary embodiment.

If the boiling stage criterion 15 is not fulfilled, in step 36 the heating element 3 is either supplied with maximum power P_{100%}, because the boiling stage does not yet seem to have been reached, or a fine adjustment of the power to be supplied to the heating element 3 is changed in order to approximate the desired temperature T_{T} even more precisely. With such a fine adjustment, electrical powers between 0% and 100% of the maximum power are also possible. In particular, a fuzzy logic is used for the fine adjustment.

If the boiling stage criterion 15 is fulfilled, it is switched to the fixed mode 24 and in step 34, the boiling detection unit (14) selects one of a plurality of fixed values P₁, P₂ for the electrical power for the heating element 3 in dependence on the desired temperature T_{T}—and/or a user input, a digital recipe and/or a recipe step—so that a constant heat supply is generated by the heating element 3. Specifically, the heating element 3 is driven with the electrical power P₁ (e.g. 100 W), the desired temperature T_{T} is equal to the boiling desired temperature T_{T1} (e.g. 98° C.) because the value P₁ in the memory 12 of the control device 10 is associated with the boiling desired temperature T_{T1}. If the desired temperature T_{T} is equal to the boiling desired temperature T_{T2} (e.g. 100° C.), the heating element 3 is driven with the electrical power P₂ (e.g. 300 W) to which P₁ in the memory 12 of the control device 10 is associated. Optionally, further fixed values such as P₃ may be stored. Alternatively, the fixed value for a fixed, constant electrical power and/or heat output of the heating element 3 can be determined and applied by means of a permanently stored function or by interpolation of permanently stored reference values depending on the desired temperature T_{T}, which is within the boiling desired temperature range T_{TB}.

Then, in step 35, in a clock cycle that is preferably 3 seconds, the actual temperature is compared to the minimum temperature T_{Min} (preferably 91° C.) and the maximum temperature T_{Max} (preferably 110° C.). If the actual temperature T_{I} leaves this temperature range or if the desired temperature T_{T} changes (not shown in FIG. 4), the control device 10 changes back to the temperature control mode 19 and proceeds with step 31. If, for example, cold water has been added to pot 2, the temperature is quickly raised again in this manner. And if the liquid in the pot 2 has completely evaporated, the heating element 2 is set to zero (P_{0%}) via step 32. Further details and embodiments for step 35 are described for the exemplary embodiment of FIG. 5, which are also applicable for this exemplary embodiment.

FIG. 5 shows a flow chart according to another exemplary configuration of the present disclosure. According to a desired temperature T_{T}, which is available to the control device 10 (e.g. by an input of the user or according to a recipe step of a digital recipe), a temperature control is performed.

Unlike the exemplary embodiment of FIG. 4, all desired temperature T_{T} pass through steps 41 and 42, preferably also steps 37 and 38. All desired temperature T_{T} also include desired temperatures far below the boiling point, of e.g. 50° C. Thus, desired temperatures T_{T} that correspond to predefined boiling desired temperatures T_{T1}, T_{T2}, T_{T3}, T_{Ti} or fall within a boiling desired temperature range T_{TB} are processed together with all other desired temperatures T_{T} that do not correspond to one of the predefined boiling desired temperatures of the plurality of predefined boiling desired temperatures T_{T1}, T_{T2}, T_{T3}, T_{Ti} or fall within a boiling desired temperature range T_{TB} through steps 41 and 42, preferably also steps 37 and 38. This reduces the complexity of the system.

In step 41 it is checked whether the actual temperature T_{I} is less than the desired temperature T_{T} minus a range B for fine adjustment. If the condition of step 41 is not fulfilled (N), heating is performed with maximum power via heating element 3. In particular, B is between 5 and 15° C. Preferably, B=10° C. If, for example, a desired temperature T_{T} of 105° C. is present, the condition of step 41 is just fulfilled when 95° C. is reached (Y).

If, for example, a desired temperature T_{T} of 98° C. is present, the condition of step 41 is just fulfilled when 88° C. is reached (Y). Although 88° C. is not yet close to the boiling temperature, e.g. at normal pressure, heating will nevertheless be carried out with a comparatively low power P₁ in the further course of the diagram. But this disadvantage of a long duration to reach the desired boiling state is accepted to realize a simple and reliable system.

In step 42, it is checked whether the actual temperature T_{I} is greater than the desired temperature T_{T} plus a range B for fine adjustment. In particular, B is between 5 and 15° C. Preferably, B=10° C. If, for example, a desired temperature T_{T} of 105° C. is present, the condition of step 41 is not fulfilled only when an actual temperature of 115° C. is present (Y). As explained above in connection with FIG. 4, the heating element 3 is set to zero power when the condition of step 42 is fulfilled, e.g. because of the evaporation of all the liquid in pot 2.

If the condition of step 42 is not fulfilled (N), which is the normal case, the desired temperature T_{T} is compared in step 37 with stored boiling desired temperatures T_{T1}, T_{T2}, T_{T3} or with stored boiling desired temperature ranges T_{TB} and, if this condition is fulfilled, the process is continued with step 33. In one embodiment, where the desired temperature T_{T} is specified by a digital recipe or recipe step such that the desired temperature T_{T} specifically corresponds to one of the stored boiling desired temperatures T_{T1}, T_{T2}, T_{T3}, the boiling desired temperature T_{T1}, T_{T2}, T_{T3} of the desired boiling state is thereby specified. In an alternative embodiment, the value P₁, P₂, P₃ of step 34 is directly specified by a user input, digital recipe or recipe step and it is continued with step 33.

If a lowest boiling desired temperature T_{T1} is e.g. 98° C. or a lower limit of a boiling desired temperature range T_{TB} is e.g. 95° C., the condition of step 37 is not fulfilled e.g. at a desired temperature T_{T} of 93° C. Step 37 has been reached because an actual temperature T_{I} of 85° C., for example, is present. In this numerical example a normal temperature control takes place. A change to the fixed mode 24 is also not desired. Because the condition of step 37 is not fulfilled (N), it is continued with step 38.

Step 38 may comprise either a maximum power P_{100%}, a fixed power for heating the pot 2 between P_{0%} and P_{100%} (e.g. 50% of the maximum power for a slower convergence to the desired temperature) or a fine adjustment of the power for the heating element 3. Preferably, step 38 includes logic for fine-tuning, in particular using fuzzy logic. A variable, electrical power is determined, with which the heating element 3 is controlled depending on the difference between the desired temperature T_{T} and the actual temperature T_{I}, preferably in a time window of about 3 seconds.

If, on the other hand, the condition of step 37 is fulfilled and a desired temperature T_{T} is present for which the fixed mode 24 has been configured, it is continued with step 33. A change to fixed mode 24 then takes place.

In step 33 it is checked if the boiling stage criterion 15 is fulfilled. In particular, a first condition of the boiling stage criterion 15 is that a slope ΔT_{I}/Δₜ of the actual temperature T_{I} over the time t is below a predefined slope threshold DT_{S}. For this purpose, a moving average of the derivative of the actual temperature T_{I} over the time t is preferably formed, preferably over a period of less than one minute. In particular, the predefined slope threshold DT_{S} is approximately 0.5° C./minute.

If a boiling desired temperature T_{T1} or a boiling desired temperature range T_{TB} of below 100° C. is stored, a second condition of the boiling stage criterion 15 can preferably be checked in step 33. In particular, an OR operation is then provided between the second condition and the first condition, such that step 33 is fulfilled when one of the two conditions is fulfilled. In particular, in the second condition, it is checked whether the absolute number (i.e., sign always >0) of a difference between the actual temperature T_{I} and the desired temperature T_{T} is not greater than 2° C. for a predefined time period ZT. Preferably, the predefined time period ZT=1 minute.

If the condition or conditions of step 33 are not yet fulfilled, the temperature control is continued via step 38.

On the other hand, if the condition or conditions of step 33 are fulfilled, the boiling desired temperature T_{Ti} or T_{T1}, T_{T2}, T_{T3} identified in step 37 or a boiling desired temperature range T_{TB} identified in step 37 is associated with a corresponding value P₁, P₂, P₃, in particular according to a stored association or association logic of the boiling detection unit 14. Alternatively or additionally, the value P₁, P₂, P₃ may be specified by a user input, a digital recipe and/or a recipe step. The heating element 3 is then supplied with electrical energy in step 34 according to the associated value P₁, P₂, P₃. In particular, the value is the electrical power or desired power for the heating element 3. The system is now in fixed mode 24. The heating element 3 dispenses a substantially constant heat output to the pot 2.

For example, the value P₁ specified above for quiet boiling is associated with the boiling desired temperature T_{T1}=98° C., which corresponds to the current desired temperature T_{T}. The heating element 3 is then supplied with a constant electrical energy of e.g. 100 W, which normally compensates the expected heat losses just below the boiling point and maintains this desired, quiet boiling state.

In step 35, the actual temperature T_{I} is compared with a lower limit, the minimum temperature T_{MIN} of e.g. 91° C., and/or an upper limit, the maximum temperature T_{MAX} of e.g. 110° C., in a regular clock cycle of a few seconds. By this it is detected if the actual temperature T_{I} leaves the boiling stage. If it is detected that the actual temperature T_{I} leaves the boiling stage, it is switched back to temperature control mode 19 and the temperature control described above is continued.

In particular, in step 35 it is additionally checked (with an OR operation) whether the desired temperature T_{T} has changed. Therefore, a change of the desired temperature T_{T}, e.g. by the user or a recipe step of a digital cooking recipe, also leads to a change back to temperature control mode 19. For example, if the boiling process is to be terminated, the desired temperature T_{T} is changed to zero, i.e. P_{0%}. The system then changes from fixed mode 24 to temperature control mode 19.

In an alternative embodiment, the exemplary embodiment of FIG. 4 is modified such that the checking T_{T}={T_{TB}} of step 30 is omitted. Instead, the AND-linked condition T_{T}≥T_{T1}, i.e., that the desired temperature T_{T} is greater than or equal to a smallest boiling desired temperature T_{T1}, is added in step 31. Optionally, this additional condition can also be added analogously in step 32. The separate step 30 can thus be omitted and the complexity reduced.

In all of the exemplary embodiments described above, the control device, e.g., the control device 10 of the food processor 1 of FIG. 1, is configured such that, in a temperature control mode 19, the control device 10 can perform temperature control based on a desired temperature T_{T} by adjusting an electrical energy supplied to the heating element 3 in dependence on the actual temperature T_{I} so that the actual temperature T_{I} approaches the desired temperature T_{T} or reaches the desired temperature T_{T}. In particular, a desired temperature T_{T} can be specified in a range of at least 37° C. and/or at most 121° C. In particular, a limited number of defined desired temperatures T_{T} are stored, between which can be selected to preset the desired temperature T_{T} of the control device 10, e.g. 85° C., 90° C., 95° C., 98° C., 100° C., 105° C., 110° C., 120° C. In particular, a continuous desired temperature cannot be set and specified. In particular, a discrete desired temperature can be set and specified.

A boiling detection unit 14 for detecting a predetermined boiling stage of the food 20 on the basis of a boiling stage criterion 15 is provided and the control device 10 is configured such that the control device 10 changes from the temperature control mode 19 to a fixed mode 24 when the boiling detection unit 14 detects the predetermined boiling stage, wherein the electrical energy supplied to the heating element 3 is kept in the fixed mode 24 at a fixed value P₁, P₂, P₃, which is dependent on the desired temperature T_{T}. In particular, the boiling detection unit 14 is part of the control device 10.

The power control is therefore only activated in certain temperature ranges around the boiling point and is switched back to temperature control when the temperature ranges are left. The boiling state is recognized, for example, by the fact that the measured temperature has a low slope or remains within a certain target temperature range for a certain time. In one embodiment, the following conditions are provided for the boiling stage criterion 15: The desired temperature specified in particular by the user or the digital recipe is between 98° C. and 105° C. or alternatively matches certain temperature values such as 98° C., 100° C. and 105° C. The measured actual temperature is greater than or equal to 91° C. (e.g. to cover a boiling point of water at 2000 m altitude of 93° C.) and less than 110° C. The measured actual temperature further has no positive slope >0.5° C./min for 30 s. Optionally, a further, in particular AND-linked condition may be that the heating power is >500 W. An OR-linked condition is further that the measured actual temperature for 1 min is in the range +/−2° C. around the desired temperature, in particular for desired temperatures <100° C. (e.g. 98° C.). If the actual temperature is <91° C. (in particular for longer than 30 s) or >110° C., it is switched back from the fixed mode to the temperature control mode. Optionally, in particular with an OR operation, it can be provided that it is switched back from the fixed mode to the temperature control mode if the slope is >+6° C./min or <−6° C./min, in particular over a period of time or a moving average value of the actual temperature over the time of preferably 10 s. An event of a sudden addition of a cold or hot medium can be considered in an improved manner in this way.

In the temperature range of boiling or cooking of the liquid food or water, the temperature control is replaced by a constant power supply and/or heat supply by the heating element. The boiling or cooking behavior achieved in this way corresponds in an improved manner to the typical user expectation and produces a cooking behavior in the pot 2 that corresponds approximately to the expected cooking on a stove in this temperature range at normal pressure.

The exemplary embodiments explained above all make it possible to achieve a reproducible cooking result and a desired steam rate particularly reliably with a particularly simple, not very complex system. For many dishes, the correct consistency is only achieved when a certain amount of water has evaporated in a controlled manner, e.g. in the case of red cabbage.

The present disclosure is based on the realization that, contrary to expectations, temporary deviations and minor deviations from a desired state of the food hardly affect the reproducibility of the cooking result in order to reliably achieve a reproducible cooking result. Up to now, methods and food processors pursuing the goal of reliably achieving a reproducible cooking result have been characterized by a very complex control in order to detect and correct as far as possible any deviation from a time-resolved planned state during the entire food preparation process.

In contrast to that, in particular around the boiling stage of the food, operation is carried out with a constant electrical energy supplied to the heating element. Tests have shown that influencing variables such as filling quantities or the quality of the mixture, e.g. by stirring, have no significant influence on the reproducibility of the cooking result if a fixed, in particular predefined value for the electrical energy supplied to the heating element is applied from the time the predetermined boiling stage is detected.

If, in one embodiment, a user or digital recipe specifies a desired temperature of 95° C. or 98° C.—alternatively between 95° C. and 99° C.—with the expectation of obtaining a quiet boiling state of the water in the pot with slight steam formation but still without (appreciable) bubbling, this state of the water and/or food can be achieved with a predefined constant first value of electrical energy or power, e.g. 100 watts, substantially independent of the height above sea level and substantially independent of the degree of filling of the pot. The same applies if, in an alternative embodiment, the user provides a corresponding user input with a corresponding desired boiling stage, e.g. boiling just before steam bubbling, via the user interface of the food processor or this is specified by a digital recipe or recipe step of a digital recipe.

If, in one embodiment, a user or digital recipe specifies a desired temperature of 100° C.—alternatively between 100° C. and 104° C.—with the expectation of obtaining a boiling state of the water in the pot with usual, normal steam formation and bubbling of boiling water, this state of the water and/or food can also be achieved substantially independently of the above-mentioned influencing variables with a predefined, constant second value of electrical energy or power, e.g. 300 watts, that is greater than the first value. The same applies if, in an alternative embodiment, the user makes a corresponding user input with a corresponding desired boiling stage, e.g. normal cooking with regular steam bubbling, via the user interface of the food processor or this is specified by a digital recipe or recipe step of a digital recipe.

If, in one embodiment, a user or digital recipe specify a desired temperature of 105° C. or greater with the expectation of obtaining a strong boiling state of the water in the pot with excessive steam formation and excessive bubbling, this state of the water and/or food can also be achieved substantially independently of the above influencing variables with a predefined, constant third value of electrical energy or power, e.g. 400 watts, that is greater than the second value, but in particular less than a maximum possible electrical energy or power. The same applies if, in an alternative embodiment, the user makes a corresponding user input with a correspondingly desired boiling stage, e.g. strong cooking with strong steam bubble formation, via the user interface of the food processor or this is specified by a digital recipe or a recipe step of a digital recipe.

In one embodiment, the fixed value for a constant electrical energy or power to be supplied to the heating element, i.e. for a constant heat output, can be determined and applied by means of a permanently stored function or by interpolation of permanently stored reference values depending on the desired temperature T_{T}, which is within a boiling desired temperature range.

As mentioned above, it was recognized that for the reproducibility of the cooking result, influencing factors such as filling level, altitude above sea level or the food composition may lead to a slight temperature shift compared to the desired temperature. However, contrary to expectations, these influences and temperature shifts do not lead to a noticeable impairment of the desired, reproducible cooking result at the end of the food preparation process, which is of good quality in the evaluation by an average user.

On the contrary, the fixed mode with a fixed, constant energy supply to the heating element from the detection of the predetermined boiling stage often fulfills the user's expectation of the state of the boiling water and/or food even more reliably than a temperature control which normally fails in a region at a particular height above sea level because the boiling point there is correspondingly lower than 100° C. due to the lower ambient pressure. In order to implement a conventional temperature control without errors even at lower ambient pressures, an ambient pressure sensor with corresponding evaluation electronics and an inclusion of its sensor measurements in the temperature control would be required, i.e., a higher complexity of the system. Another example is a pot that is contaminated in the area of the temperature sensor, which may lead to the temperature sensor always measuring a lower temperature than is actually present. Here, too, the conventional temperature control may fail, whereas using the fixed mode can achieve the desired condition in the pot and the desired, reproducible cooking result can be achieved particularly reliably.

In the embodiment in which the electrical energy supplied to the heating element in the fixed mode is kept at a fixed value that depends on a user input, the user input is made by the user and/or transmitted to the control device via a user interface, in particular of the food processor. A user input may be implemented by means of a selection field by which the user may select one desired boiling stage from a plurality of boiling stages—for example, for a boiling just before steam bubbling, for a normal cooking with regular steam bubbling, or for a strong cooking with strong steam bubbling. In particular, the selection field may describe the boiling stages to be selected between by means of text and/or graphics. In one embodiment, the boiling stages to be selected between can each be a digital recipe that can be selected from a list of recipes.

In the embodiment in which the electrical energy supplied to the heating element in the fixed mode is kept at a fixed value specified by a digital recipe or a recipe step of a digital recipe, this specification is transmitted to the control device and/or implemented by the control device in the execution of a recipe or recipe step.

A further aspect of the present disclosure relates to a food processor configured such that the food processor performs or can perform the method according to the method described at the beginning. A food processor for preparing a food in a pot is provided, wherein the food processor comprises the pot, a heating element for heating the pot and/or a food in the pot, and a temperature sensor for determining an actual temperature of the pot and/or a food in the pot. The food processor may further comprise a tool for mixing and/or chopping a food in the pot. A control device is configured such that, in a temperature control mode, the control device can perform temperature control based on a desired temperature by adjusting an electrical energy supplied to the heating element in response to the actual temperature so that the actual temperature approaches or reaches the desired temperature. The food processor comprises a boiling detection unit for detecting a predetermined boiling stage of the food, and the control device is configured such that the control device changes from the temperature control mode to a fixed mode when the boiling detection unit detects the predetermined boiling stage, wherein the electrical energy supplied to the heating element in the fixed mode is kept at a fixed value that is dependent on the desired temperature. The definitions, configurations and effects of the aspect of the present disclosure described above are also applicable to this aspect of the present disclosure.

A further aspect of the present disclosure relates to a food processor. In particular, the food processor is configured such that the food processor can perform the method according to one of the preceding claims. For preparing a food in a pot, the food processor comprises the pot and a heating element for heating the pot and/or a food in the pot. The food processor further comprises a control device, a user interface, and a temperature sensor for determining an actual temperature of the pot or the food in the pot. The control device is configured such that, in a fixed mode, an electrical energy supplied to the heating element is kept at a fixed value when a user makes a user input via a user interface to enter a desired boiling stage, e.g., for boiling just before steam bubbling, for normal cooking with regular steam bubbling, or for strong cooking with strong steam bubbling. In other words, this user input results in a change or activation of the fixed mode. A reproducible cooking result can be achieved in this way particularly reliably with a system that has a reduced complexity. A desired boiling stage is a desired boiling state. In one embodiment, the desired temperature is defined by the desired boiling stage of the user input.

A further aspect of the present disclosure relates to a computer program product comprising instructions which, when the program of the computer program product is executed by a processor, in particular of a control device, preferably of a food processor, cause the processor to perform the steps of the method according to the aspect of the present disclosure described at the beginning.

The following definitions, configurations and effects apply to both the method and to the food processor, and may also apply to the computer program product.

A food processor is a food preparation device that can prepare a food by heating or mixing or chopping. This can be performed by manual operation by a user or by automatic execution of a stored recipe or individual recipe steps. The boiling point detection device of the food processor may be comprised by the control device of the food processor. The boiling point detection device and/or part of the control device may, for example, be outsourced to an external computing unit (such as a cloud computer, server, smartphone or tablet PC) that is communicatively connected to the control device of the food processor. A desired temperature or user input for the desired boiling stage may be specified, for example, by a user via a user interface, which is in particular comprised by the food processor, or by a digital recipe. A digital recipe is a data set defining a plurality of recipe steps. A recipe step may comprise control commands and/or cooking parameters for one or a plurality of electrically operable functional components of the food processor. These individual recipe steps are then executed automatically or semi-automatically. For example, a recipe step may specify a desired temperature. The control device then operates the heating element, for example, on the basis of the desired temperature. An electrical energy supplied to the heating element can be kept to a fixed value in the fixed mode by controlling the heating element with a constant target value for the energy to be supplied. In one embodiment, a power control is provided so that the electrical energy supplied to the heating element, e.g., an actual power, is as close as possible to or equal to the target power, e.g., a target power. If the food processor also comprises a tool for mixing and/or chopping, the control device may also control the tool. The control device then transmits control commands and/or signals to a drive whose electric motor rotates the tool. A temperature sensor for determining an actual temperature transmits digital or analog signals correlating to the measured temperatures to the control device. Either the control device determines the actual temperature by receiving the signals from the sensor or by receiving and signal processing the received signals from the sensor.

A boiling stage is a state of a liquid or water-containing food or water in the pot, in which a phase transformation from liquid to gaseous occurs at least partially due to heating by the heating element. Preferably, the predetermined boiling stage, which is defined in particular by means of a boiling stage criterion that may comprise one or a plurality of conditions, is defined in such a way that in the predetermined boiling stage steam bubbles rise from the pot bottom to the surface of the liquid food and burst there audibly to the human ear and release steam.

In general, control (closed-loop control) means that a controlled variable (e.g. actual temperature T_{I}) and a reference variable (e.g. desired temperature T_{T}) are compared with each other in a control loop and, depending on the difference between the reference variable and the controlled variable, a manipulated variable (e.g. electrical energy, in particular electrical power, to be supplied to the heating element) is adjusted such that the controlled variable approaches the reference variable.

At 100° C., the so-called boiling point, water begins to evaporate at normal pressure, i.e. approx. 1 bar ambient pressure. The boiling temperature depends on the altitude above sea level. The higher above sea level cooking takes place, the sooner the water begins to boil. For the preparation of food, a distinction is often made between so-called “silent boiling” and loud boiling, which is also referred to as cooking (e.g. boiling water). When a liquid food is heated, silent boiling begins first. At temperatures as low as approx. 90° C. or 95° C., small bubbles with water vapor form at the bottom of the pot which slowly rise to the top and burst at the surface. Only when the temperature is the same throughout the entire pot, the so-called cooking or loud boiling begins, during which the large steam bubbles audibly burst at the water surface. Sensitive foods such as sausages, dumplings, fresh ravioli or gnocchi heated in boiling water should be prepared in still boiling water with regard to an improved cooking result in terms of quality and reproducibility. At normal pressure, an average water temperature of 90° C. already leads to rising air bubbles accompanied by steam formation due to heating of the pot bottom. At 95° C., liquid water increasingly evaporates to steam. At 100° C., water evaporates at high speed. Foods such as potatoes are cooked in normal boiling water and foods such as red cabbage are cooked in strong boiling water with a high steam rate with regard to an improved cooking result in terms of quality and reproducibility.

In a configuration of the method and/or a configuration of the control device, it is provided that it is checked whether the desired temperature corresponds to one of a plurality of predefined boiling desired temperatures or falls within a predefined boiling desired temperature range. In this way, an expected boiling state of the food can be obtained particularly reliably with a not very complex system. In particular, this check is a condition of a boiling stage criterion, preferably an AND-linked condition, which in one embodiment can be brought forward to one or a plurality of steps at the beginning or during a temperature control. The complexity of the system can thus be further reduced.

In a configuration of the method and/or a configuration of the control device, it is provided that a first predefined boiling desired temperature (e.g. T_{T1}=91° C.), which is less than 100° C., is associated with a first value (e.g. P₁) for the electrical energy supplied to the heating element. In one configuration, it is provided that a second predefined boiling desired temperature (e.g. T_{T2}=100° C.), which is greater than or equal to 100° C., is associated with a second value (e.g. P₂) for the electrical energy supplied to the heating element. In one configuration, it is provided that a third predefined boiling desired temperature (e.g. T_{T3}=105° C.), which is greater than 100° C., is associated with a third value (e.g. P₃) for the electrical energy supplied to the heating element. In one configuration, at least two, preferably at least or exactly three, and/or at most eight, particularly preferably at most five, predefined values for the electrical energy supplied to the heating element are associated to a respective boiling desired temperature or a respective boiling desired temperature range. In this way, an expected boiling state of the food can be obtained particularly reliably with a not very complex system.

By “value for the electrical energy supplied to the heating element” is meant a parameter for controlling the heating element, which should cause a constant heating power of the heating element.

Preferably, the value for the electrical energy supplied to the heating element is predefined and/or stored in a memory together with the associated boiling desired temperature or the boiling desired temperature range. Particularly preferably, the value includes the electrical power to be supplied to the heating element. The parameter is then the electrical power, which can be specified with the unit watt, or a digital or analog signal value correlating therewith for controlling the heating element. If the electrical power supplied to the heating element is controlled to a desired power value, the value is this desired power value. Alternatively, the value may be a measure of the current supplied to the heating element that correlates with the heating power to be delivered by the heating element.

In one configuration, the plurality of predefined boiling desired temperature ranges are not below 95° C. In one configuration, the predefined boiling desired temperature range is not below 95° C. or the predefined boiling desired temperature ranges are not below 95° C. The complexity of the system can thus be further reduced.

In a configuration of the method and/or a configuration of the control device, it is provided that it is checked that the actual temperature is greater than a predefined minimum temperature and/or less than a predefined maximum temperature. A not very complex system, which particularly reliably enables a reproducible cooking result, can be obtained in this way. In particular, this check is a condition of a boiling stage criterion, especially an AND-linked condition, which in one embodiment can be brought forward to one or a plurality of steps during a temperature control. The complexity of the system can thus be further reduced.

In one configuration, the predefined minimum temperature (T_{Min}) is at least 80° C. and/or at most 91° C. or 93° C., particularly preferably exactly 91° C. In one configuration, the predefined maximum temperature (T_{Max}) is greater than 105° C. or 110° C. and/or less than 120° C. Particularly preferably, the predefined maximum temperature is 110° C. In this way, the system can be operated in the fixed mode for a particularly long time and computing capacity can be saved. A slow response time of the system is accepted, because it was recognized that this has no significant influence on the quality and reproducibility of the cooking result and the system can be simplified and computing capacity can be saved. This advantage also applies to at least the following two configurations.

In a configuration of the method and/or a configuration of the control device, it is provided that the control device changes from the fixed mode back to the temperature control mode if the actual temperature falls below the predefined minimum temperature or exceeds the predefined maximum temperature. In one embodiment, it is additionally provided that the control device changes from the fixed mode back to the temperature control mode when a change of the desired temperature occurs.

In a configuration of the method and/or a configuration of the control device, it is provided that in the temperature control mode the electrical energy supplied to the heating element is controlled to the value zero (P_{0%}) if the actual temperature exceeds the predefined maximum temperature, and/or the electrical energy supplied to the heating element is raised to a heating value or a maximum possible value (P_{100%}) if the actual temperature falls below the predefined minimum temperature. A heat-up value is between the value zero (P_{0%}) and the maximum possible value (P_{100%})

In one configuration of the method and/or a configuration of the control device, it is provided that a boiling stage criterion is checked to detect the predetermined boiling stage, wherein the boiling stage criterion comprises at least one predefined condition. Thus, only one condition may already be sufficient. Preferably, however, there are a plurality of conditions, but in particular not more than eight conditions.

In one embodiment, the boiling stage criterion is defined such that the boiling stage criterion can be checked exclusively on the basis of the actual temperature or the measurement data of the temperature sensor, i.e. on the basis of the preferably time-resolved signals supplied by the temperature sensor for detecting the actual temperature.

In one configuration, the boiling stage criterion comprises the following condition: a slope (ΔT_{I}/Δₜ) of the actual temperature (T_{I}) over time (t) falls below a predefined slope threshold. A slope is a difference of two actual temperatures over the time difference of the measurement of these two actual temperatures. A slope corresponds to the first derivative of a function T_{I}(t) of the actual temperature as a function of time. In one embodiment, the actual temperature (T_{I}) is a moving average. A moving average averages over a plurality of signals of the actual temperature measured by the temperature sensor to provide the actual temperature for checking the boiling stage criterion. Preferably, the time period over which the moving average is averaged is at least 5 seconds and/or at most 1 minute, most preferably 0.5 minutes. Problems caused by measurement inaccuracies and other fluctuations due to external influences can thus be prevented and a particularly reliable detection of the boiling stage can be enabled.

In one configuration, the predefined slope threshold is at least 0.2° C./minute and/or at most 5° C./minute, particularly preferably about 0.5° C./minute. A particularly reliable detection of a boiling stage of the food can thus be achieved.

In one configuration, the boiling stage criterion comprises the following condition if a boiling desired temperature that is less than 100° C. is stored: the amount of a difference between the actual temperature and the desired temperature is not greater than at least 1° C. and/or at most 5° C., particularly preferably not greater than about 2° C., for a predefined period of time. In other words, a symmetrical, concurrent tolerance band is provided around the desired temperature, and the condition of the boiling stage criterion is fulfilled if the actual temperature value does not leave the tolerance band for the predefined time period. In particular, this condition can be provided with an OR operation in addition to the above-described condition relating to the slope. This enables even more reliable detection of the boiling stage.

In one configuration, the predefined time period is at least 0.5 minutes and/or at most 10 minutes, particularly preferably about one minute.

In one configuration, a clock cycle is at least 1 second, preferably 3 seconds, particularly preferably at least 5 seconds, and/or at most 30 seconds, particularly preferably at most 10 seconds. Preferably, the clock cycle is exactly 5 seconds. In particular, the clock cycle is applied in fixed mode. A checking of, for example, the actual temperature against one or a plurality of temperature limits then takes place regularly at a time interval of the clock cycle. Again, a slow response time of the system is accepted, because it was recognized that this has no significant influence on the quality and reproducibility of the cooking result and the system can be simplified and computing power can be saved by this.

In one configuration, it is provided that in the fixed mode of the control device the fixed value of the electrical energy supplied to the heating element is dependent on the desired temperature, a user input or a digital recipe, in particular on a recipe step of the digital recipe. In particular, a desired boiling state can be specified or selected by the user input or a digital recipe, based on which the corresponding fixed value of electrical energy for the heating element is then used by the control unit to achieve this boiling state. In this way, a reproducible cooking result can be achieved particularly reliably with a system that has a reduced complexity.

In one configuration it is provided that in the fixed mode of the control device the fixed value of the electrical energy supplied to the heating element is specified by a user input or a digital recipe, in particular by a recipe step of the digital recipe. For users, this provides a possibility to specify a fixed value of electrical energy for the heating element, even under special environmental conditions, which are adapted to these special environmental conditions to achieve the desired boiling state. A digital recipe or a recipe step of a digital recipe can in this way directly and specifically effect the desired boiling state. In this way, a reproducible cooking result can be achieved particularly reliably with a system that has a reduced complexity.

1. Method for preparing a food in a pot by means of a food processor comprising the pot, a heating element for heating the pot and a food in the pot, and a temperature sensor (4) for determining an actual temperature (T_{I}) of the pot or of the food in the pot, comprising the following steps:
Performing temperature control by a control device in a temperature control mode based on a desired temperature (T_{T}) by adjusting an electrical energy supplied to the heating element in dependence on the actual temperature (T_{I}) so that the actual temperature (T_{I}) approaches or reaches the desired temperature (T_{T}),
Detecting a predetermined boiling stage of the food by a boiling detection unit; and
Changing from the temperature control mode to a fixed mode of the control device when the boiling detection unit detects the predetermined boiling stage, wherein the electrical energy supplied to the heating element is kept at a fixed value (P₁, P₂, P₃) in the fixed mode, which is not value zero,
the method further comprising the steps of:
Checking whether the desired temperature (T_{T}) matches one of a plurality of predefined boiling desired temperatures (T_{T1}, T_{T2}, T_{T3}, T_{Ti}) or falls within a predefined boiling desired temperature range (T_{TB}),
wherein a first predefined boiling desired temperature (T_{T1}), which is less than 100° C., is associated with a first value (P₁) for the electrical energy supplied to the heating element, and a second predefined boiling desired temperature (T_{T2}), which is greater than or equal to 100° C., is associated with a second value (P₂) for the electrical energy supplied to the heating element.

2. The method of claim 1, characterized in that the first value (P1) and the second value (P2) are each a parameter for controlling the heating element in such a way that a respective constant heating power of the heating element is caused.

3. The method of claim 2, characterized in that the first value (P1) and the second value (P2) each include a respective electrical power to be supplied to the heating element, which can be specified with the unit watt or a value correlating therewith for controlling the heating element.

4. The method of claim 2, characterized in that the first value (P1) and the second value (P2) each are predefined values and stored in a memory together with the associated boiling desired temperature or the boiling desired temperature range.

5. Method for preparing a food in a pot by means of a food processor comprising the pot, a heating element for heating the pot and/or a food in the pot, and a temperature sensor (4) for determining an actual temperature (T_{I}) of the pot or of the food in the pot, comprising the following steps:
Performing temperature control by a control device in a temperature control mode based on a desired temperature (T_{T}) by adjusting an electrical energy supplied to the heating element in dependence on the actual temperature (T_{I}) so that the actual temperature (T_{I}) approaches or reaches the desired temperature (T_{T}),
Detecting a predetermined boiling stage of the food by a boiling detection unit; and
Changing from the temperature control mode to a fixed mode of the control device when the boiling detection unit detects the predetermined boiling stage, wherein the electrical energy supplied to the heating element is kept at a fixed value (P₁, P₂, P₃) in the fixed mode.

6. The method of claim 5, characterized by the step:
Checking whether the desired temperature (T_{T}) matches one of a plurality of predefined boiling desired temperatures (T_{T1}, T_{T2}, T_{T3}, T_{Ti}) or falls within a predefined boiling desired temperature range (T_{TB}).

7. The method of claim 6, characterized in that a first predefined boiling desired temperature (T_{T1}), which is less than 100° C., is associated with a first value (P₁) for the electrical energy supplied to the heating element, and a second predefined boiling desired temperature (T_{T2}), which is greater than or equal to 100° C., is associated with a second value (P₂) for the electrical energy supplied to the heating element.

8. The method of claim 6, characterized in that the plurality of predefined boiling desired temperatures (T_{Ti}) and/or the predefined boiling desired temperature range (T_{TB}) are not below 95° C.

9. The method of claim 5, characterized by the step:
Checking whether the actual temperature (T_{I}) is greater than a predefined minimum temperature (T_{Min}) and/or less than a predefined maximum temperature (T_{Max}).

10. The method of claim 9, characterized in that the predefined minimum temperature (T_{Min}) is between 80° C. and 91° C. and/or the predefined maximum temperature (T_{Max}) is greater than 105° C. or 110° C.

11. The method of claim 9, characterized in that the control device changes from the fixed mode back to the temperature control mode if the actual temperature (T_{I}) falls below the predefined minimum temperature (T_{Min}) or exceeds the predefined maximum temperature (T_{Max}).

12. The method of claim 9, characterized in that in temperature control mode the electrical energy supplied to the heating element is controlled to the value zero (P_{0%}) if the actual temperature (T_{I}) exceeds the predefined maximum temperature (T_{Max}), and/or the electrical energy supplied to the heating element is raised to a heating value or a maximum possible value (P_{100%}) if the actual temperature (T_{I}) falls below the predefined minimum temperature (T_{Min}).

13. The method of claim 5, characterized in that a boiling stage criterion is checked to detect the predetermined boiling stage, wherein the boiling stage criterion comprises at least one predefined condition.

14. The method of claim 13, characterized in that the boiling stage criterion comprises the following condition: a slope (ΔT_{I}/Δₜ) of the actual temperature (T_{I}) over time (t) falls below a predefined slope threshold (DT_{S}).

15. The method of claim 14, characterized in that the predefined slope threshold (DT_{S}) is at least 0.2° C./minute and/or at most 5° C./minute.

16. The method of claim 13, characterized in that, in the case of a boiling desired temperature (T_{T1}) which is less than 100° C., the boiling stage criterion comprises the following condition: the amount of a difference between the actual temperature (T_{I}) and the desired temperature (T_{T}) does not become greater than at least 1° C. and/or at most 5° C. for a predefined time period (ZT), in particular for a predefined time period (ZT) of at least 0.5 minutes and/or at most 10 minutes.

17. The method of claim 5, characterized in that in the fixed mode of the control device the fixed value (P₁, P₂, P₃) of the electrical energy supplied to the heating element is dependent on or specified by the desired temperature (T_{T}), a user input or a digital recipe.

18. Food processor configured such that the food processor performs the method of claim 1.
